(19) United States
(12) Patent Application Publication
(10) Pub. No.: US 2024/0156109 A1
(43) Pub. Date: May 16, 2024

(54) MICROORGANISMS FOR DOUGH PRODUCTION

(71) Applicant: AB Enzymes GmbH, Darmstadt (DE)

(72) Inventors: Maria Johanna VAN DER WERF, Darmstadt (DE); Andreas HOLKENBRINK, Darmstadt (DE); Alexander HENRICH, Darmstadt (DE); Detlef GOELLING, Darmstadt (DE)

(73) Assignee: AB Enzymes GmbH, Darmstadt (DE)

(21) Appl. No.: 18/282,444

(22) PCT Filed: Mar. 17, 2022
(86) PCT No.: PCT/EP2022/057037

§ 371 Date: Sep. 15, 2023

(30) Foreign Application Priority Data
Mar. 18, 2021 (EP) 21163517.2

(51) Int. Cl. A21D 8/04; A23L 3/3571

(52) U.S. Cl. CPC A21D 8/045; A23L 3/3571

(57) ABSTRACT

The present invention relates to a method of producing a dough, comprising (i) admixing a lactic acid producing microorganism and a propionic acid producing microorganism to flour and water; and (ii) incubating the admixture of step (i) for a first incubation period, wherein the lactic acid producing microorganism produces lactic acid and the propionic acid producing microorganism produces propionic acid, wherein the lactic acid producing microorganism and the propionic acid producing microorganism are capable of growing in a medium consisting of 50% (w/w) flour in water. The present invention also relates to a composition, preferably a starter culture for bakery good production, comprising viable cells of a lactic acid producing microorganism and viable cells of a propionic acid producing microorganism, wherein the lactic acid producing microorganism and the propionic acid producing microorganism are capable of growing in a medium consisting of 50% (w/w) flour in water. The present invention also relates to uses, baked goods, and methods related to the aforesaid method and composition.

The present invention relates to a method of producing a dough, comprising (i) admixing a lactic acid producing microorganism and a propionic acid producing microorganism to flour and water; and (ii) incubating the admixture of step (i) for a first incubation period, wherein the lactic acid producing microorganism produces lactic acid and the propionic acid producing microorganism produces propionic acid, wherein the lactic acid producing microorganism and the propionic acid producing microorganism are capable of growing in a medium consisting of 50% (w/w) flour in water. The present invention also relates to a composition, preferably a starter culture for bakery good production, comprising viable cells of a lactic acid producing microorganism and viable cells of a propionic acid producing microorganism, wherein the lactic acid producing microorganism and the propionic acid producing microorganism are capable of growing in a medium consisting of 50% (w/w) flour in water. The present invention also relates to uses, baked goods, and methods related to the aforesaid method and composition.

Methods for increasing the shelf life of food products are known in the art and include in particular reduction of water content, pickling, reduction of germ count e.g. by heating, handling under conditions reducing contamination risk, addition of preservatives, and combinations thereof. One of the known preservatives, propionic acid and its salts, can be added directly to a foodstuff; however, in other approaches, it was attempted to provide microbial cultures producing propionic acid in situ, e.g. WO 2013/174793 A1 proposed Propionibacteria alone or in combination with bacteria of the genus Lactobacillus as protective cultures and for production of food or feed products. WO 2013/174792 A1 taught strains of Lactobacillus with antifungal properties. Suomalainen and Mäyrä-Mäkinen (1999), Lait 79:165 suggested a combination of Propionibacterium and Lactobacillus strains in the production of yoghurt and quark. Ryzhkova et al. (2018) Mikologiy I Fitopatologiya 52:144 proposed a combination of specific Propionibacteria with several Lactobacillus species to inhibit mold growth.

Baked goods, in particular a variety of breads, have been an important component in daily nutrition of the world's population. Due to their relatively high water activity and nutrient content, baked goods are prone to spoilage, mostly by molds. In accordance, increasing the shelf life of baked goods mostly aims at preventing growth of molds; to that end, addition of preservatives is typically used, including addition of propionic acid and its salts. As for other food products, also for baked goods it was proposed to produce antimicrobial compounds in situ. WO 2012/085049 A2 proposed a biphasic sourdough fermentation, in which in a first step lactic acid is produced by lactic acid bacteria, and in a second step, after killing the lactic acid bacteria by heating, Propionibacteria are added. WO 2004/105495 A2 suggested a heat-inactivated bread premix comprising a bacterially produced amylase and a separately bacterially produced antimicrobial agent. Javanainen and Linko (1993), J Cereal Sci 18: 171, as well as Javanainen and Linko (1993), J Cereal Sci 18:75 used a combination of Propionibacterium and Lactobacillus strains in rye sour-dough fermentation and wheat bread production, respectively, however required addition of salts and of complex nutrients in the form of yeast extract, which is undesirable in bread. A similar approach was followed by Ryzhkova (2009), Biotekhnologiya 2:29-37.

There is, nonetheless, a need for improved mans and methods for increasing the shelf-life of baked goods. This problem is solved by the means and methods disclosed herein and in particular by the embodiments characterized in the claims and described herein below.

In accordance, the present invention relates to a method of producing a dough, comprising (i) admixing a lactic acid producing microorganism and a propionic acid producing microorganism to flour and water; and (ii) incubating the admixture of step (i) for a first incubation period, causing the lactic acid producing microorganism to produce lactic acid and the propionic acid producing microorganism to produce propionic acid.

In general, terms used herein are to be given their ordinary and customary meaning to a person of ordinary skill in the art and, unless indicated otherwise, are not to be limited to a special or customized meaning. As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements. Also, as is understood by the skilled person, the expressions “comprising a” and “comprising an” preferably refer to “comprising one or more”, i.e. are equivalent to “comprising at least one”.

Further, as used in the following, the terms “preferably”, “more preferably”, “most preferably”, “particularly”, “more particularly”, “specifically”, “more specifically” or similar terms are used in conjunction with optional features, without restricting further possibilities. Thus, features introduced by these terms are optional features and are not intended to restrict the scope of the claims in any way. The invention may, as the skilled person will recognize, be performed by using alternative features. Similarly, features introduced by “in an embodiment” or similar expressions are intended to be optional features, without any restriction regarding further embodiments of the invention, without any restrictions regarding the scope of the invention and without any restriction regarding the possibility of combining the features introduced in such way with other optional or non-optional features of the invention.

As used herein, the term “standard conditions”, if not otherwise noted, relates to IUPAC standard ambient temperature and pressure (SATP) conditions, i.e. preferably, a temperature of 25° C. and an absolute pressure of 100 kPa; also preferably, standard conditions include a pH of 7. Moreover, if not otherwise indicated, the term “about” relates to the indicated value with the commonly accepted technical precision in the relevant field, preferably relates to the indicated value±20%, more preferably ±10%, most preferably ±5%. Further, the term “essentially” indicates that deviations having influence on the indicated result or use are absent, i.e. potential deviations do not cause the indicated result to deviate by more than ±20%, more preferably ±10%, most preferably ±5%. Thus, “consisting essentially of” means including the components specified but excluding other components except for materials present as impurities, unavoidable materials present as a result of processes used to provide the components, and components added for a purpose other than achieving the technical effect of the invention. For example, a composition defined using the phrase “consisting essentially of” encompasses any known acceptable additive, excipient, diluent, carrier, and the like. Preferably, a composition consisting essentially of a set of components will comprise less than 5% by weight, more preferably less than 3% by weight, even more preferably less than 1% by weight, most preferably less than 0.1% by weight of non-specified component(s).

The degree of identity (e.g. expressed as “% identity”) between two biological sequences, preferably DNA, RNA, or amino acid sequences, can be determined by algorithms well known in the art. Preferably, the degree of identity is determined by comparing two optimally aligned sequences over a comparison window, where the fragment of sequence in the comparison window may comprise additions or deletions (e.g., gaps or overhangs) as compared to the sequence it is compared to for optimal alignment. The percentage is calculated by determining, preferably over the whole length of the polynucleotide or polypeptide, the number of positions at which the identical residue occurs in both sequences to yield the number of matched positions, dividing the number of matched positions by the total number of positions in the window of comparison and multiplying the result by 100 to yield the percentage of sequence identity. Optimal alignment of sequences for comparison may be conducted by the local homology algorithm of Smith and Waterman (1981), by the homology alignment algorithm of Needleman and Wunsch (1970), by the search for similarity method of Pearson and Lipman (1988), by computerized implementations of these algorithms (GAP, BESTFIT, BLAST, PASTA, and TFASTA in the Wisconsin Genetics Software Package, Genetics Computer Group (GCG), 575 Science Dr., Madison, W(I), or by visual inspection. Given that two sequences have been identified for comparison, GAP and BESTFIT are preferably employed to determine their optimal alignment and, thus, the degree of identity. Preferably, the default values of 5.00 for gap weight and 0.30 for gap weight length are used. In the context of biological sequences referred to herein, the term “essentially identical” indicates a % identity value of at least 80%, preferably at least 90%, more preferably at least 98%, most preferably at least 99%. As will be understood, the term essentially identical includes 100% identity. The aforesaid applies to the term “essentially complementary” mutatis mutandis.

The methods specified herein may comprise steps in addition to those explicitly mentioned above. For example, in the method of producing a dough, further steps may relate, e.g., to rehydrating, resuspending, and/or pre-growing the lactic acid producing microorganism and/or the propionic acid producing microorganism for step (i), and/or admixing further compounds in step (i) and/or after step (ii). Also, the dough produced preferably is used as a pre-dough in the production of a main dough for baked product production as specified herein below. Preferably, the dough furthermore is formed to a bakery product and baked. As is understood by the skilled person, dough production may comprise producing a pre-dough, which is the used for production of a main dough, which is then used for production of the actual baked goods. Thus, the dough produced according to steps (i) and (ii) may be a pre-dough or a main dough. Also, one or more of the method steps may be performed by automated equipment.

The terms “flour” and “water” are known to the skilled person. Preferably, the flour is a powder generated by grinding grains, roots, beans, nuts, or other fruits of edible plants or parts thereof. Preferably, the flour is cereal flour, more preferably wheat, rye, barley, oat, corn, rice, spelt, sorghum millet, emmer, einkorn, kamut, or buckwheat flour, more preferably is wheat flour. The flour may be any type and may have any residual ash mass deemed appropriate by the skilled person; preferably, the flour is pastry flour, all-purpose flour, or bread flour. The water, preferably, is food-grade water. Preferably, flour and water are used as-is, in particular, preferably, no measures are taken to reduce the microbial count therein, such as sterilization.

The term “dough”, is used herein in a broad sense relating to any and all mixtures comprising the indicated compounds. Preferably, the dough comprises at least 10% (w/w) flour, more preferably at least 20% (w/w) flour, still more preferably at least 30% (w/w) flour, even more preferably at least 40% (w/w) flour, most preferably at least 50% (w/w) flour. Thus, the dough may be a liquid dough such as a batter or a semisolid or solid dough, preferably is a semisolid or solid dough. The dough comprises at least one type of flour, more preferably comprises one type of flour; thus, the dough may also comprise different types of flour, both with regards to the source organism of the flour and to the flour type; thus, as non-limiting examples, the dough may e.g. be a mixed wheat flour/rye flour dough, and/or may be a mixed whole grain/bread flour dough. Preferably, the dough comprises the lactic acid producing microorganism, the propionic acid producing microorganism, flour, and water; more preferably, the dough essentially consists of the lactic acid producing microorganism, the propionic acid producing microorganism, flour, and water; most preferably, the dough consists of the lactic acid producing microorganism, the propionic acid producing microorganism, flour, and water. Also preferably, the dough essentially consists of the lactic acid producing microorganism, the propionic acid producing microorganism, flour, water, and up to 5% (w/w), preferably up to 2.5% (w/w), more preferably up to 1% (w/w) glucose or sucrose; most preferably, the dough consists of the lactic acid producing microorganism the propionic acid producing microorganism, flour, water, and up to 5% (w/w), preferably up to 2.5% (w/w), more preferably up to 1% (w/w) glucose or sucrose. In step (i), the pH of the dough may be checked and, optionally, adjusted to be slightly acidic, e.g. to be of from 5.5 to 7, preferably of from 6 to 6.5. After step (ii), the pH of the dough preferably is of from 4 to 6, preferably of from 4.5 to 5.5.

Also after step (ii), the lactic acid content of the dough preferably is of from 0.1% (w/w) to 1% (w/w), preferably of from 0.2% (w/w) to 0.7% (w/w), calculated per flour mass. Also after step (ii), preferably, the propionic acid content of the dough is at least 0.02% (w/w), preferably at least 0.05% (w/w), more preferably is of from 0.03% (w/w) to 5% (w/w), preferably of from 0.04% (w/w) to 2% (w/w), calculated per flour mass Preferably, the dough of steps (i) and (ii) is devoid of added sugar, yeast extract, soy flour, casein hydrolysate, and/or whey permeate. Optionally, the dough may comprise a bread improver or other bread ingredient, preferably selected from bread enzymes (e.g. amylase), salts (e.g. sodium chloride, an acetate salt, a fumarate salt, a citrate salt, and/or a carbonate salt), and/or antioxidants (e.g. ascorbic acid, or ascorbate salts). Preferably, the dough and/or baked goods produced therefrom are for human or animal food consumption, are human food or animal feed. Preferably, the dough and/or baked goods produced therefrom are food, i.e. for human consumption.

The term “baked good” includes any and all goods made from a dough or batter and cooked by baking, frying, or deep frying, preferably by baking. Preferred baked goods are those that are traditionally produced with a slightly acidic dough, preferably with a pH as specified herein above. Preferably, the baked good is a bread, including flatbreads, bagels, breadrolls, and the like; a cracker; a pastry product; a tart or pie; or a viennoiserie. Preferably, the baked good is made from an unleavened dough, i.e. lacking added yeast, e.g. in case of an unleavened flatbread such as tortilla, chapati, dosa, and the like. More preferably, the baked good is made from a leavened dough, such as loaf bread such as toast, baguette, and the like; leavened flatbread; or viennoiserie. Even more preferably, the baked good is a loaf bread, more preferably a bread comprising at least 10% wheat flour of the total amount of flour, even more preferably is a wheat bread. As will be understood, in case of leavened bakery goods, the method preferably comprises optional steps (iii) and (iv), i.e. a method including production of a pre-dough and main dough, is preferred.

The term “lactic acid producing microorganism”, as used herein, relates to any microorganism producing at least 0.8 mol lactic acid from 1 mol glucose under anaerobic conditions. Preferably, the lactic acid producing microorganism produces more than 1 mol, preferably more than 1.5 mol, lactic acid from 1 mol glucose under anaerobic conditions. Thus, preferably, the lactic acid producing microorganism is a homofermentative lactic acid producing microorganism. Preferably, the lactic acid producing microorganism produces lactic acid and/or grows in a medium consisting of 50% (w/w) flour, preferably wheat flour, more preferably all-purpose wheat flour, in water. Also preferably, the lactic acid producing microorganism grows under anaerobic conditions, more preferably the lactic acid producing microorganism is aerotolerant. Thus, preferably, the lactic acid producing microorganism produces lactic acid from glucose and grows in the presence of oxygen, preferably of up to a fraction of 10% oxygen, more preferably up to a fraction of 21% oxygen, i.e. in the presence of ambient air. Preferably, the lactic acid producing microorganism is a microorganism producing and secreting at least one amylase as specified elsewhere herein. Thus, preferably, the lactic acid producing microorganism has the property of producing lactic acid from starch under appropriate conditions, preferably in a medium consisting of 50% (w/w) flour in water. Preferably, the lactic acid producing microorganism produces at least one compound inhibiting the natural flora of the flour, of the water, and/or of other compounds optionally added to the dough, while, preferably, not inhibiting the propionic acid producing microorganism. Various types of inhibitory compounds, as well as methods for detecting them, are known in the art, e.g. from Siedler et al. (2019), Curr Op Biotechnol 56:138.

Preferably, the lactic acid producing microorganism is a unicellular organism, preferably a prokaryotic or a eukaryotic microorganism. The eukaryotic organism preferably is a yeast. More preferably, the lactic acid producing microorganism is a prokaryotic organism, preferably an eubacterium. Preferably, the lactic acid producing microorganism is a lactic acid bacterium, more preferably a member of the genus Lactobacillus, still more preferably a homofermentative Lactobacillus. Preferably, the lactic acid producing microorganism is a strain of Lactobacillus johnsonii, Lactilactobacillus sakei, Companilactobacillus farciminis, Lactobacillus acidophilus, Lactobacillus amylolyticus, Lactobacillus amylovorus, Lactobacillus crispatus, Companilactobacillus alimentarius, Companilactobacillus crustorum, Companilactobacillus heilongjiangensis, Companilactobacillus mindensis, Companilactobacillus nantensis, Companilactobacillus paralimentarius, Schleiferilactobacillus harbinensis, Latilactobacillus curvatus, Loigolactobacillus coryniformis, Ligilactobacillus acidipiscis, Lactobacillus murinus, Lactiplantibacillus plantarum, Lactiplantibacillus fabifermentans, Lactiplantibacillus pentosus, Lactiplantibacillus xiangfangensis, Furfurilactobacillus rossiae, Furfurilactobacillus siliginis, Paucilactobacillus vaccinostercus, Paucilactobacillus oligofermentans, Limosilactobacillus fermentum, Limosilactobacillus frumenti, Limosilactobacillus mucosae, Limo silactobacillus panis, Limosilactobacillus pontis, Limo silactobacillus reuteri, Limo silactobacillus secaliphilus, Levilactobacillus brevis, Levilactobacillus acidifarinae, Levilactobacillus hammesii, Levilactobacillus koreensis, Levilactobacillus namurensis, Levilactobacillus parabrevis, Levilactobacillus spicheri, Levilactobacillus zymae, Lactobacillus fructivorans, or Fructilactobacillus sanfranciscensis. The nomenclature used for members of the former genus Lactobacillus preferably is the one proposed in Zheng et al. (2020), Int J Syst Evol Microbiol 70:2782. More preferably, the lactic acid producing microorganism is a strain of L. johnsonii, of Lactilactobacillus sakei, or of Companilactobacillus farciminis, more preferably is L. johnsonii strain LCT (Lactotecon) 986, deposited at the DSMZ under deposit number DSM 33691 or a bacterial strain having a 16S RNA at least 95%, preferably at least 97%, more preferably at least 98% identical, most preferably at least 99%, identical to the 16S RNA of said strain; Lactilactobacillus sakei strain LCT (Lactotecon) 142, deposited at the DSMZ under deposit number DSM 33690 or a bacterial strain having a 16S RNA at least 95%, preferably at least 97%, more preferably at least 98% identical, most preferably at least 99%, identical to the 16S RNA of said strain; or is Companilactobacillus farciminis strain LCT (Lactotecon) 1916, deposited at the DSMZ under deposit number DSM 33692 or a bacterial strain having a 16S RNA at least 95%, preferably at least 97%, more preferably at least 98% identical, most preferably at least 99%, identical to the 16S RNA of said strain. Still more preferably, the lactic acid producing microorganism is Lactobacillus johnsonii strain LCT 986, deposited at the DSMZ under deposit number DSM 33691, Lactilactobacillus sakei strain LCT 142, deposited at the DSMZ under deposit number DSM 33690; or Companilactobacillus farciminis strain LCT 1916, deposited at the DSMZ under deposit number DSM 33692. Still more preferably, the lactic acid producing microorganism is Lactobacillus johnsonii strain LCT 986, deposited at the DSMZ under deposit number DSM 33691, Lactilactobacillus sakei strain LCT 142, deposited at the DSMZ under deposit number DSM 33690, most preferably is Lactobacillus johnsonii strain LCT 986, deposited at the DSMZ under deposit number DSM 33691. Preferably, Lactilactobacillus sakei strain LCT (Lactotecon) 142, deposited at the DSMZ under deposit number DSM 33690, was reclassified as Lactobacillus johnsonii LCT142 and may, therefore, also be referred to under this designation.

The term “propionic acid producing microorganism”, as used herein, relates to any microorganism producing propionic acid from glucose and/or, preferably, from lactic acid under anaerobic conditions. Preferably, the propionic acid producing microorganism produces at least 0.25 mol, more preferably at least 0.4 mol, even more preferably at least 0.6 mol, propionic acid from 1 mol lactic acid under anaerobic conditions. Thus, preferably, the propionic acid producing microorganism is a microorganism performing propionic acid fermentation. Preferably, the propionic acid producing microorganism produces propionic acid and/or grows in co-culture with a lactic acid producing microorganism as specified herein in a medium consisting of 50% (w/w) flour in water. Also preferably, the propionic acid producing microorganism grows under anaerobic conditions, more preferably the propionic acid producing microorganism is aerotolerant. Thus, preferably, the propionic acid producing microorganism produces propionic acid from lactic acid and grows in the presence of oxygen, preferably of up to a fraction of 10% oxygen, more preferably up to a fraction of 21% oxygen, i.e. in the presence of ambient air. Preferably, the propionic acid producing microorganism is a microorganism producing and secreting at least one amylase as specified elsewhere herein. Preferably, the propionic acid producing microorganism has the property of producing propionic acid from lactic acid under appropriate conditions, preferably in co-culture with a lactic acid producing microorganism as specified herein in a medium consisting of 50% (w/w) flour in water. Preferably, the lactic acid producing microorganism produces at least one compound inhibiting the natural flora of the flour, of the water, and/or of other compounds optionally added to the dough, while, preferably, not inhibiting the lactic acid producing microorganism; thus, the propionic acid producing microorganism preferably produces and secretes an inhibitory compounds as specified herein above.

Preferably, the propionic acid producing microorganism is a unicellular organism, preferably a prokaryotic or a eukaryotic microorganism. The eukaryotic organism preferably is a yeast. More preferably, the propionic acid producing microorganism is a prokaryotic organism, preferably an eubacterium. Preferably, the propionic acid producing microorganism is a propionic acid producing member of the family Propionibacteriaceae, more preferably of the genus Propionibacterium, or a propionic acid producing member of the family Lactobacillaceae, e.g. Lentilactobacillus buchneri or Lentilactobacillus diolivorans, more preferably of the genus Propionibacterium. Preferably, the propionic acid producing microorganism is a food-grade microorganism, preferably a strain of Propionibacterium freudenreichii, Acidipropionibacterium jensenii, Acidopropionibacterium thoenii, or Acidipropionibacterium acidipropionici. More preferably, the propionic acid producing microorganism is a strain of P. freudenreichii, still more preferably P. freudenreichii ssp. freudenreichii. Even more preferably, the propionic acid producing microorganism is Propionibacterium freudenreichii strain LCT (Lactotecon) P1, deposited at the DSMZ under deposit number DSM 33694 or a bacterial strain having a 16S RNA at least 95%, preferably at least 97%, more preferably at least 98% identical, most preferably at least 99%, identical to the 16S RNA of said strain; most preferably, the propionic acid producing microorganism is Propionibacterium freudenreichii strain LCT P1, deposited at the DSMZ under deposit number DSM 33694.

In view of the above, the present invention preferably relates to a method of producing a dough, comprising (i) admixing a lactic acid producing microorganism and a propionic acid producing microorganism to flour and water; and (ii) incubating the admixture of step (i) for a first incubation period, causing the lactic acid producing microorganism to produce lactic acid and the propionic acid producing microorganism to produce propionic acid, wherein the lactic acid producing microorganism is Lactobacillus johnsonii strain LCT 986, deposited at the DSMZ under deposit number DSM 33691, Lactilactobacillus sakei strain LCT 142, deposited at the DSMZ under deposit number DSM 33690; or Companilactobacillus farciminis strain LCT 1916, deposited at the DSMZ under deposit number DSM 33692 and/or wherein the propionic acid producing microorganism is Propionibacterium freudenreichii strain LCT P1, deposited at the DSMZ under deposit number DSM 33694.

The amounts of lactic acid producing microorganism and propionic acid producing microorganism to be added to the dough are adjusted by the skilled person in dependence of planned temperature and duration of the first incubation period, desired propionic acid concentration in the dough after the first incubation period, and other factors known to the skilled person. As will be understood by the skilled person, the dosage of the lactic acid producing microorganism and the dosage of the propionic acid producing microorganism are preferably adjusted independently. Preferably, the lactic acid producing microorganism is dosed at at least 10¹¹ colony forming units (cfu)/kg flour, more preferably at least 10¹⁰ cfu/kg flour, even more preferably 10⁹ cfu/kg flour, most preferably at least 10⁸ cfu/kg flour. Also preferably, the lactic acid producing microorganism is dosed at of from 10⁸ cfu/kg flour to 10¹³ cfu/kg flour, more preferably of from 10⁹ cfu/kg flour to 10¹² cfu/kg flour, most preferably of from 10¹⁰ cfu/kg flour to 10¹¹ cfu/kg flour. Preferably, the propionic acid producing microorganism is dosed at at least 10¹¹ colony forming units (cfu)/kg flour, more preferably at least 10¹⁰ cfu/kg flour, even more preferably 10⁹ cfu/kg flour, most preferably at least 10⁸ cfu/kg flour. Also preferably, the lactic acid producing microorganism is dosed at of from 10⁸ cfu/kg flour to 10¹³ cfu/kg flour, more preferably of from 10⁹ cfu/kg flour to 10¹² cfu/kg flour, most preferably of from 10¹⁰ cfu/kg flour to 10¹¹ cfu/kg flour.

The term “amylase”, as used herein, relates to a hydrolytic enzyme using starch as a substrate and producing mono-, di-, and/or oligosaccharides as products. Preferably, the amylase is an alpha-amylase (EC 3.2.1.1), a beta-amylase (EC 3.2.1.2), or a gamma-amylase (EC 3.2.1.3), more preferably is an alpha-amylase, most preferably a bacterial alpha-amylase.

As is understood by the skilled person, the term “growth”, with respect to microorganisms, relates to an increase in cell mass, total cell count, and/or an increase in viable cell number. Thus, preferably, in step (ii), the number of cells of the lactic acid producing microorganism and/or the number of cells of the propionic acid producing microorganism increase(s) compared to the numbers of cells added in step (i); also preferably, the number of viable cells of the lactic acid producing microorganism and/or the number of viable cells of the propionic acid producing microorganism increase(s) compared to the numbers of cells added in step (i). Determination of total cell counts and of live cell counts (e.g. as colony forming units, cfu) are standard methods of microbiology; preferably, such live cell count determination is performed on elective or selective media under appropriate conditions. Similarly, methods for determining acid production and identifying and quantifying acids produced by a microorganism are well known in the art and include in particular those as specified herein in the Examples. Moreover, production of inhibitory compounds or amylases can be tested by standard microbiological methods, e.g. by determining inhibition zones or lysis zones, respectively, surrounding colonies of the microorganism of interest on appropriate test plates. Since the natural flora of flour included in a dough causes the dough to spoil after incubation over a period of 24 h under standard conditions, inhibition of natural flora can also be determined by producing a dough according to the method as specified herein, followed by optical and/or olfactory inspection, wherein inhibition of the natural flora is identified if a homogenous dough with an agreeable, fresh smell is obtained after the first incubation period.

As is also understood by the skilled person, the expression “a microorganism” may also relate to one or more, preferably to a multitude of, cells of said microorganism. Thus, the expression “admixing a microorganism” is understood to be equivalent to “admixing cells of a microorganism”, preferably to “admixing living cells of a microorganism”.

The method of producing a dough comprises step (i) admixing a lactic acid producing microorganism and a propionic acid producing microorganism to flour and water; as indicated herein above, at least one of said lactic acid producing microorganism and said propionic acid producing microorganism is an amylase-producing microorganism, preferably said lactic acid producing microorganism is an amylase-producing microorganism.

The terms “mixing” and “admixing” are understood by the skilled person and are used interchangeably herein. Preferably, the terms include any and all measures deemed appropriate by the skilled person and causing the indicated components and optional further components to become mixed, preferably to homogeneity. Preferably, admixing comprises kneading. Unless otherwise indicated, the compounds can be added for mixing in any arbitrary order. Also, components may be added in a premixed form; e.g. the lactic acid producing microorganism and the propionic acid producing microorganism may be mixed before addition to other components or may be provided as a mixture; or the lactic acid producing microorganism and the propionic acid producing microorganism or a mixture thereof may be admixed to the water, followed by admixing the flour. Also preferably, in the dough of steps (i) and (ii) the amount of yeast added is less than 1% (w/w), preferably less than 0.1% (w/w), more preferably in and before steps (i) and (ii) no yeast is added to the dough in step (i). Preferably, the temperature in step (i) is the same as specified herein above, more preferably, is 25° C.±5° C.

The method of producing a dough further comprises step (ii) incubating the admixture of step (i) for a first incubation period; as indicated above, this causes the lactic acid producing microorganism to produce lactic acid and the propionic acid producing microorganism to produce propionic acid. Preferably, during the first incubation period, propionic acid is produced in the dough to an amount as specified elsewhere herein. Preferably, the propionic acid is produced by the propionic acid producing microorganism at least in part from the lactic acid produced by the lactic acid producing microorganism. More preferably, during the first incubation period, propionic acid and lactic acid are produced in the dough to amounts as specified elsewhere herein, more preferably the propionic acid content of the dough at the end of step (ii) is at least 0.02% (w/w), more preferably at least 0.05% (w/w). Preferably, the first incubation period in step (ii) is performed at a temperature of from 3° C. to 50° C., more preferably of from 10° C. to 40° C., still more preferably of from 15° C. to 39° C., most preferably at around 37° C., preferably at 37° C.±5° C. Preferably, the first incubation period in step (ii) has a duration of from 0.5 hour to 72 hours, more preferably of from 12 hours to 48 hours, still more preferably of from 16 to 36 hours. As the skilled person understands, the aforesaid incubation durations are preferred for incubations at room temperature or higher, whereas different periods may be preferable for different temperatures; in particular, incubation at lower temperatures may require longer incubation periods. Preferably, the incubation period is adjusted such that the propionic acid concentration in the dough reaches a value as specified herein above. More preferably, the amounts of microorganisms added are adjusted such that the propionic acid concentration in the dough reaches a value as specified herein above after a pre-determined incubation period. Preferably, the first incubation period is a period of dough resting, i.e. essentially without agitation of the dough or only with mild agitation, in particular without kneading.

The dough may be used for production of a baking good after step (ii) and optionally a step of forming. A batter, preferably, may be used to cover a foodstuff. Thus, after step (ii), e.g., preferably, an unleavened type of baked good, such as an unleavened flatbread, may be produced from the dough. The dough may also be dried and ground to be used as a basis for baked good production. Preferably, the dough after step (ii) is used as a pre-dough; thus, preferably, step (ii) is followed by step (iii), more preferably, by steps (iii) and (iv). Preferably, in case the dough is used as a pre-dough, the lactic acid producing microorganism and the propionic acid producing organism are not inactivated after step (ii), in particular are not heat-inactivated after step (ii).

Optionally, the method of producing a dough further comprises step (iii) admixing the admixture of step (ii) to flour, water, and yeast, preferably to form a main dough. As will be understood, the terms flour and water are used in the context of step (iii) in the same meaning as specified herein above; as will also be understood, the pre-dough may, in principle, be produced with a different flour than the main dough. The amounts of flour, water, and yeast are adjusted according to the product envisaged and essentially are the same as in standard baking protocols. The admixture of step (ii), which may also be referred to as pre-dough, may be admixed to the other components completely or only parts of the pre-dough may be used. Preferably, the pre-dough is mixed to the main dough at a ratio of from 1:100 to 1:2, preferably of from 1:50 to 1:3, more preferably of from 1:20 to 1:5; also preferably, the pre-dough is mixed to the main dough at a ratio of about 1:5, about 1:10, or about 1:20, wherein the ratios indicate the fraction of pre-dough weight in weight of the main dough (including the pre-dough).

The term “yeast”, as used herein, includes any and all types of yeast deemed appropriate by the skilled person. Preferably, the yeast is a member of the genus Saccharomyces, more preferably a strain of Saccharomyces cerevisiae. Suitable yeasts are known in the art and are particularly referred to as baker's yeast. Preferably, yeast is added in step (iii) at an amount of 0.5% (w/w) to 5% (w/w), more preferably of from 1% (w/w) to 4% (w/w), most preferably of from 2% (w/w) to 3.5% (w/w).

Optionally, the method of producing a dough further comprises step (iv) incubating the admixture of step (iii) for a second incubation period. Preferably, the temperature in the second incubation period is selected from the temperatures indicated for the first incubation period; the temperature of the second incubation period preferably is selected independently from the temperature of the first incubation period; more preferably the temperature during the second incubation period is about 32° C., preferably 32° C.±5° C. The duration of the second incubation period preferably is adjusted such that an appropriate degree of fermentation, in particular gas production, is obtained, and will typically be adjusted by the skilled person according to experience. Preferably, the duration of the second incubation period is of from 0.25 hour to 24 hours, preferably of from 0.5 hour to 16 hours, most preferably of from 1 hour to 6 hours. As the skilled person understands, the aforesaid incubations are preferred for incubations at room temperature or above, whereas different periods may be preferable for different temperatures; in particular, incubation at lower temperatures may require longer incubation periods. Preferably, the second incubation period is a period of dough resting, i.e. without agitation of the dough, in particular without kneading.

Preferably, the method of producing a dough is a method of increasing a shelf life of a baked good, preferably a pastry product, more preferably a bread, most preferably a wheat bread. Preferably, increasing the shelf life comprises delaying spoilage, preferably molding, of a product baked from a dough produced as specified by at least two, preferably at least three, more preferably at least four, most preferably at least five, days, compared to the same dough produced without said lactic acid producing microorganism and without said propionic acid producing microorganism. As will be understood, spoilage is a statistical process and is preferably measured by incubating baking goods or parts thereof, such as slices, under conditions suitable for spoilage and determining how many of the baked goods or parts thereof are visibly spoiled after a given time; thus, as used herein, the expression “delaying spoilage” relates to an increase in time required until the same number of baked goods or parts thereof is spoiled. More preferably, increasing the shelf life comprises preventing spoilage, preferably molding, of a product baked from a dough produced as specified for at least three, preferably at least five, more preferably at least six, most preferably at least seven, days in at least 90% of the baked goods or parts thereof evaluated. Preferred methods for determining delay and/or prevention of spoilage are shown herein in the Examples.

Advantageously, it was found in the work underlying the present invention that by combining amylase positive microorganisms producing lactate from starch with propionic acid producing microorganisms in a dough, baked products with increased shelf-life can be produced. Moreover, it was found that certain strains of Lactobacillus and Propionibacterium have no auxotrophies preventing their growth and/or acid production in a medium consisting of flour and water; also, it was found that certain strains of Lactobacillus and Propionibacterium are capable of growing and/or producing acid in a medium having the reduced water activity of 50% (w/w) flour in water, such that they are particularly suited for baked product production.

The definitions made above apply mutatis mutandis to the following. Additional definitions and explanations made further below also apply for all embodiments described in this specification mutatis mutandis.

The present invention further relates to a composition, preferably a starter culture for baked good production, comprising viable cells of a lactic acid producing microorganism and viable cells of a propionic acid producing microorganism, wherein at least one of said lactic acid producing microorganism and said propionic acid producing microorganism, preferably wherein said lactic acid producing microorganism, is an amylase-producing microorganism.

The term “composition”, as used herein, relates to a composition of matter comprising the compounds as specified and optionally one or more acceptable carrier(s). Preferably, the composition is a non-naturally occurring composition. Preferably, the composition is a food-grade composition; thus, the composition, preferably, comprises the compounds as specified and the carrier is a food-grade carrier. The composition may as well comprise further compounds, such as stabilizers, bread improvers, and the like, all of which, preferably, are food grade compounds.

The composition comprises viable cells of the microorganisms as specified. Thus, preferably, at least 25%, more preferably at least 50%, most preferably at least 75% of the microorganism cells comprised in the composition are viable. Also preferably, the composition comprises each of the indicated microorganism at a viable cell count of at least 10⁶ viable cells/g composition, more preferably at least 10⁸ viable cells/g composition, most preferably at least 10⁹ viable cells/g composition. As will be understood, a dough produced by the method of producing a dough as specified herein above may be a composition as specified.

The present invention also relates to a method of producing a baked good, preferably a bread, comprising the steps of the method of producing a dough as specified herein above and the further step of baking the dough.

The present invention also relates to a use of a lactic acid producing microorganism and a propionic acid producing microorganism in production of a dough, preferably by a method comprising the steps of the method of producing a dough as specified herein above.

The present invention also relates to a baked good produced or producible by a method as specified herein.

The present invention also relates to a method of producing a dough, preferably a pre-dough, comprising mixing into a dough (I) a microorganism producing at least one antifungal compound and (II) a microorganism producing at least one antibacterial compound, wherein said antifungal compound is propionic acid.

The term “antibacterial compound” is understood by the skilled person to relate to any and all compounds causing inhibition of growth of at least one bacterial strain when present in the growth medium at a concentration of 1 mM or less, preferably 1 μM or less; preferred antibacterial compounds are inhibitory compounds as specified herein above having antibacterial properties. Preferably, the antibacterial compound is an antibacterial compound produced by a lactic acid producing microorganism as specified herein above. Thus, preferably, the microorganism producing at least one antibacterial compound is a lactic acid producing microorganism as specified herein above; also preferably, the microorganism producing at least one antifungal compound is a propionic acid producing microorganism as specified herein above.

The present invention also relates to a bacterium, preferably an isolated bacterium isolated from its natural environment, being
(I) Lactobacillus johnsonii strain LCT 986, deposited at the DSMZ under deposit number DSM 33691;
(II) Lactilactobacillus sakei strain LCT 142, deposited at the DSMZ under deposit number DSM 33690;
(III) Companilactobacillus farciminis strain LCT 1916, deposited at the DSMZ under deposit number DSM 33692 or
(IV) Propionibacterium freudenreichii strain LCT P1, deposited at the DSMZ under deposit number DSM 33694.

As used herein, the term “bacterium” in the context of the strains as specified above relates to bacterial cells, which may be comprised in any and all preparation deemed appropriate by the skilled person. Preferably, the preparation is a starter culture or a food product as specified herein below, in particular a dough. Preferably, the bacterium is a living bacterium. Also preferably, the bacterium is obtained by and/or maintained by growth in a non-natural growth medium, preferably a medium as specified herein in the Examples or in a dough as specified elsewhere herein.

The present invention also relates to a starter culture or a food product, preferably a dough or a baked good, comprising a bacterium according to the present invention.

The term “food product” includes each and every product for human or animal food consumption, i.e. includes food and feed. Preferably, the food product is food, i.e. for human consumption. Preferably, the food product is a fermented food product, more preferably a dough or baked good as specified elsewhere herein, a fermented dairy product, or a fermented food product. Most preferably, the food product is a dough or baked good.

Also, the present invention relates to a use of a bacterium as specified herein above in the manufacture of a food product or a fermented ingredient thereof, preferably a dough or a fermentate.

The present invention also relates to a spent medium of a bacterium as specified herein above or a product thereof.

The term “spent medium” is used herein in the broadest sense to include any and all media in which a bacterium as specified herein above was incubated, including fractions thereof obtained e.g. by physical and/or chemical separation and purification measures, such as centrifugation, precipitation, extraction, sieving, chromatography, and the like. Thus, the spent medium may contain bacteria or may be cell-free. Also, in case the spent medium contains bacteria, these may be living cells or non-living cells, e.g. heat-inactivated cells. Preferably, the medium used in the preparation of a spent medium allows for measureable metabolic activity of the bacterium, thus, the medium used in the preparation of a spent medium preferably has a water activity of at least 0.91, more preferably at least 0.93, more preferably at least 0.95. Thus, the medium used in the preparation of spent medium preferably is a culture medium for the bacterium or a dough as specified herein above. In case the spent medium is used in the preparation of a food product, it may be preferable to use a composition compatible with downstream use as a medium for the preparation of spent medium, e.g. in the production of a dough, a dough or a starch-comprising medium may be used, or in the production of a fermented dairy product a dairy product may be used. Preferably, the cell number of the bacterium in the spent medium is or was at least 10⁴/ml, more preferably at least 10⁶/ml, still more preferably 10⁸/ml, most preferably at least 10¹⁰/ml. Preferably, the bacterium was incubated in said spent medium for at least 2 hours, more preferably at least 6 hours, still more preferably at least 12 hours, even more preferably at least 24 hours. Preferably, the bacterium was incubated in said spent at its optimal growth temperature ±10° C., more preferably ±5° C. Incubation at a temperature of from 2° C. to 10° C. may, however, also be envisaged. The bacteria do not necessarily have to grow or have grown in the spent medium during incubation; thus, preferably, the total cell number and/or the life cell count does not decrease by more than 50%, more preferably does not decrease by more than 20%, still more preferably is constant, even more preferably increases by at least 20%, most preferably increases by at least 100%, during the incubation. More preferably, the total cell number does not decrease by more than 50%, more preferably does not decrease by more than 20%, still more preferably is constant, even more preferably increases by at least 20%, most preferably increases by at least 100%, during the incubation. Preferably, the spent medium comprises at least one inhibitory compound as specified herein above.

Preferably, the spent medium as specified herein above is used for production of a fermentate. The term “fermentate” is known to the skilled person to relate to a dried spent medium of a food-grade microorganism, preferably a lactic acid producing microorganism and/or a propionic acid producing microorganism as specified herein above. Preferably, the spent medium is spray-dried to obtain the fermentate. Preferably, the medium used in the production of the fermentate is a food ingredient. The medium used in the production of the fermentate may, however, also be a dough as specified herein above.

The term “food ingredient” is used herein to relate to any and all ingredients of a food or feed. Preferably, the food ingredient is a carbohydrate-containing food ingredient such as syrup, a dextrose solution, and the like. As used herein, a food ingredient after contacting with a bacterium as specified herein above is referred to as “fermented food ingredient”. Thus, e.g. a fermentate or a pre-dough are fermented food ingredients.

The present invention also relates to a use of a spent medium of the present invention for prevention of spoilage of a food product, preferably of a dough.

As is understood by the skilled person, the water content of a dough is significantly higher than that of a baked good; as a consequence, while a baked good tends to spoil by molding as specified herein above, a dough or other food product with high water content tends to spoil by bacterial growth; thus, spoilage in the context of a use of a spent medium preferably comprises growth and/or metabolism of undesired bacteria in said food product, more preferably of bacteria of the intrinsic flora of at least one component of said food product. Also preferably, spoilage in the context of a use of a spent medium comprises development of a displeasing smell and/or taste, wherein whether a smell and/or taste is displeasing is preferably determined by exposing a multitude of human subjects to said smell and/or taste and determining that the smell and/or taste is displeasing if said assessment is provided by a majority of the subjects exposed. In accordance with the above, in the context of the use of a spent medium, the food product preferably has a water activity of at least 0.91, more preferably at least 0.93, more preferably at least 0.95, preferably at the time of addition of the spent medium to the food product. Thus, the food product preferably is a dough, a diary product, or a fermented food product. More preferably, the food product in such case is a dough, still more preferably a low-yeast dough, the term low-yeast dough relating to a dough with less than 0.5% (w/w), more preferably less than 0.2% (w/w), most preferably without, added yeast.

In view of the above, the following embodiments are particularly envisaged:

Embodiment 1: A method of producing a dough, comprising
(i) admixing a lactic acid producing microorganism and a propionic acid producing microorganism to flour and water; and
(ii) incubating the admixture of step (i) for a first incubation period, wherein the lactic acid producing microorganism produces lactic acid and the propionic acid producing microorganism produces propionic acid.

Embodiment 2: The method of embodiment 1, (i) wherein the lactic acid producing microorganism produces lactic acid in a medium consisting of 50% (w/w) flour in water and/or (ii) wherein at least one of said lactic acid producing microorganism and said propionic acid producing microorganism, preferably wherein said lactic acid producing microorganism, is an amylase-producing microorganism.

Embodiment 3: The method of embodiment 1 or 2, wherein an admixture of said lactic acid producing microorganism and said propionic acid producing microorganism produces propionic acid in a medium consisting of 50% (w/w) flour in water.

Embodiment 4: The method of any one of embodiments 1 to 3, wherein the lactic acid producing microorganism and/or the propionic acid producing microorganism is/are capable of producing acid and/or growing in a medium consisting of 50% (w/w) flour in water.

Embodiment 5: The method of any one of embodiments 1 to 5, wherein in a co-culture of said lactic acid producing microorganism and said propionic acid producing microorganism, both said strains grow in a medium consisting of 50% (w/w) flour in water.

Embodiment 6: The method of any one of embodiments 1 to 5, wherein said lactic acid producing microorganism produces at least 0.8 mol lactic acid from 1 mol glucose under anaerobic conditions, preferably is a homofermentative lactic acid producing microorganism.

Embodiment 7: The method of any one of embodiments 1 to 6, wherein said lactic acid producing microorganism and/or said propionic acid producing microorganism is/are aerotolerant, preferably, wherein said lactic acid producing microorganism and said propionic acid producing microorganism are aerotolerant.

Embodiment 8: The method of any one of embodiments 1 to 7, wherein said lactic acid producing microorganism is a Lactobacillus strain, preferably a L. johnsonii strain, a Lactilactobacillus strain, preferably L. sakei, or a Companilactobacillus strain, preferably a C. farciminis strain.

Embodiment 9: The method of any one of embodiments 1 to 7, wherein said lactic acid producing microorganism is a Lactobacillus johnsonii strain, a Lactilactobacillus sakei strain, a Lactiplantibacillus plantarum strain, or a Companilactobacillus farciminis strain; and/or wherein said propionic acid producing microorganism is a Propionibacterium freudenreichii, strain.

Embodiment 10: The method of any one of embodiments 1 to 9, wherein said lactic acid producing microorganism produces at least one compound inhibiting the natural flora of the flour, of the water, and/or of other compounds optionally added to the dough.

Embodiment 11: The method of any one of embodiments 1 to 10, wherein said lactic acid producing microorganism is an aerotolerant strain of Lactobacillus johnsonii, Lactilactobacillus sakei, Lactiplantibacillus plantarum strain, or Companilactobacillus farciminis strain, said lactic acid producing microorganism preferably further producing at least one compound inhibiting the natural flora of the flour, of the water, and/or of other compounds optionally added to the dough.

Embodiment 12: The method of embodiment 10 or 11, wherein said production of inhibitory compounds is tested (i) by determining inhibition zones surrounding colonies of said lactic acid producing microorganism on test plates and/or (ii) by producing a dough followed by optical and/or olfactory inspection, wherein inhibition of the natural flora is identified if a homogenous dough with an agreeable, fresh smell obtained after the first incubation period.

Embodiment 13: The method of any one of embodiments 1 to 12, wherein said lactic acid producing microorganism is
(a) Lactobacillus johnsonii strain LCT 986, deposited at the DSMZ under deposit number DSM 33691;
(b) Lactilactobacillus sakei strain LCT 142, deposited at the DSMZ under deposit number DSM 33690; or
(c) Companilactobacillus farciminis strain LCT 1916, deposited at the DSMZ under deposit number DSM 33692.

Embodiment 14: The method of any one of embodiments 1 to 13, wherein said propionic acid producing microorganism is a strain of a Propionibacterium species or a Lactobacillus species, preferably of P. freudenreichii.

Embodiment 15: The method of any one of embodiments 1 to 14, wherein said propionic acid producing microorganism is Propionibacterium freudenreichii strain LCT P1, deposited at the DSMZ under deposit number DSM 33694.

Embodiment 16: The method of any one of embodiments 1 to 15, wherein the first incubation period in step (ii) has a duration of from 0.5 hour to 72 hours.

Embodiment 17: The method of any one of embodiments 1 to 16, wherein the first incubation period in step (ii) is performed at a temperature of from 3° C. to 50° C.

Embodiment 18: The method of any one of embodiments 1 to 17, wherein the first incubation period in step (ii) is performed until the dough reaches a pH of 6 or less, preferably a pH of 5.5 or less.

Embodiment 19: The method of any one of embodiments 1 to 18, wherein after the first incubation period, the propionic acid content of the dough is at least 0.02% (w/w), preferably at least 0.05% (w/w).

Embodiment 20: The method of any one of embodiments 1 to 19, wherein in step (ii), the number of cells of the lactic acid producing microorganism and/or the number of cells of the propionic acid producing microorganism increase compared to the numbers of cells added.

Embodiment 21: The method of any one of embodiments 1 to 20, wherein in step (ii), the number of viable cells of the lactic acid producing microorganism and/or the number of viable cells of the propionic acid producing microorganism increases compared to the numbers of cells added.

Embodiment 22: The method of any one of embodiments 1 to 21, wherein said method further comprises steps
(iii) admixing the admixture of step (ii) to flour, water, and yeast; and
(iv) incubating the admixture of step (iii) for a second incubation period.

Embodiment 23: The method of any one of embodiments 1 to 19, wherein said flour is a wheat flour.

Embodiment 24: The method of any one of embodiments 1 to 23, wherein said flour and/or water is/are non-sterile.

Embodiment 25: The method of any one of embodiments 1 to 24, wherein said admixture of step (ii) is devoid of added sugar, yeast extract, soy flour, casein hydrolysate, and/or whey permeate.

Embodiment 26: The method of any one of embodiments 1 to 25, wherein in step i) and ii), the amount of yeast added to the dough is less than 1% (w/w), preferably less than 0.1% (w/w), more preferably wherein in and before steps i) and ii) no yeast is added.

Embodiment 27: The method of any one of embodiments 1 to 26, wherein the lactic acid producing microorganism and the propionic acid producing microorganism are pre-mixed before admixture to the flour and the water.

Embodiment 28: The method of any one of embodiments 1 to 20, wherein said method is a method of increasing a shelf life of a baked good, preferably a wheat bread.

Embodiment 29: A composition, preferably a starter culture for bakery good production, comprising viable cells of a lactic acid producing microorganism and viable cells of a propionic acid producing microorganism.

Embodiment 30: The composition of embodiment 29, wherein said lactic acid producing microorganism and/or said propionic acid producing microorganism is/are a lactic acid producing microorganism and/or a propionic acid producing microorganism as specified in any one of embodiments 1 to 15.

Embodiment 31: The composition of embodiment 29 or 30, wherein said composition produces propionic acid in a medium consisting of 50% (w/w) flour in water.

Embodiment 32: The composition of any one of embodiments 29 to 31, further comprising at least one of water, flour, and/or one or more bread improvers.

Embodiment 33: A method of producing a baked good, preferably bread, comprising the steps of the method according to any one of embodiments 1 to 27 and the further step of baking the dough.

Embodiment 34: The method of embodiment 33, wherein said bakery product is a bread, preferably wheat bread.

Embodiment 35: Use of a lactic acid producing microorganism and a propionic acid producing microorganism, preferably as specified in any one of embodiments 1 to 15, in production of a dough, preferably in production of a bread, preferably by a method comprising the steps pf any one of embodiments 1 to 28.

Embodiment 36: A baked good produced or producible by the method according to any one of embodiments 1 to 28 and 33 to 34.

Embodiment 37: The baked good of embodiment 36, wherein said baked good has an increased shelf-life, preferably has an increased period of non-spoilage by mold.

Embodiment 38: A method of producing a dough, preferably a pre-dough, comprising mixing into a dough (I) a microorganism producing at least one antifungal compound and (II) a microorganism producing at least one antibacterial compound, wherein said antifungal compound is propionic acid.

Embodiment 39. A bacterium, preferably an isolated bacterium isolated from its natural environment, being
(I) Lactobacillus johnsonii strain LCT 986, deposited at the DSMZ under deposit number DSM 33691;
(II) Lactilactobacillus sakei strain LCT 142, deposited at the DSMZ under deposit number DSM 33690;
(III) Companilactobacillus farciminis strain LCT 1916, deposited at the DSMZ under deposit number DSM 33692; or
(IV) Propionibacterium freudenreichii strain LCT P1, deposited at the DSMZ under deposit number DSM 33694.

Embodiment 40: A starter culture or a food product comprising a bacterium according to embodiment 39.

Embodiment 41: The starter culture or food product of embodiment 40, wherein said food product is a dough or a baked good.

Embodiment 42. Use of a bacterium according to embodiment 39 in the manufacture of a food product or a fermented ingredient thereof, preferably a dough or a fermentate, preferably according to the method of any one of embodiments 1 to 28 and 33 to 34.

Embodiment 43: A spent medium of a bacterium according to embodiment 39.

Embodiment 44: Use of the spent medium of embodiment 43 for prevention of spoilage of a dough.

Embodiment 45: The use of embodiment 44, wherein said spoilage is development of a displeasing smell and/or taste.

Embodiment 46: The use of embodiment 44 or 45, wherein said dough is a low-yeast dough, preferably a dough without added yeast.

All references cited in this specification are herewith incorporated by reference with respect to their entire disclosure content and the disclosure content specifically mentioned in this specification.

### FIGURE LEGENDS

FIG. 1: Volatile acid contents in doughs of Example 3. Volatile acids in the dough were determined by extracting the dough with water (1:1 [v/v]), followed by derivatization with 1-octanol and analysis by GC-MS as described by van der Werf et al (2007) Anal. Biochem. 370:17.

FIG. 2: Spoilage of bread slices of Example 4; indicated are numbers of slices with no visible growth of mold (not moldy, bright column sections), and the numbers of slices with visible growth of molds (dark column sections). A) blank, B) positive control (0.1% Ca-Propionate), C) LCT 142, and D) LCT 986.

The following Examples shall merely illustrate the invention. They shall not be construed, whatsoever, to limit the scope of the invention.

### EXAMPLE 1: ELECTION OF CANDIDATE MICROORGANISMS

The candidate microorganisms were selected from QPS (qualified presumption of safety) bacterial strains.

As candidate lactic acid producing microorganisms, lactic acid producing bacteria were elected which produce amylase, are homofermentative, and are aerotolerant. The best candidates identified were
Strain LCT 142, which is strain DSM 33690 deposited at DSMZ;
Strain LCT 986, which is strain DSM 33691 deposited at DSMZ; and
Strain LCT 1916, which is strain DSM 33692 deposited at DSMZ.

As candidate propionic acid producing microorganisms, Propionibacterium strains were elected which are aerotolerant and produce propionic acid from lactic acid. The best candidate was Propionibacterium strain LCT P1, which is strain DSM 33694 deposited at DSMZ

### EXAMPLE 2: PRE-DOUGH PRODUCTION

Lactobacillus strains were pre-grown in standard MRS medium to the stationary phase. Propionibacteria were pre-grown in in standard NaLa medium (20 g/l caseinpepton; 10 g/l yeast extract and 16 g/l NaLactate) to the stationary phase.

For pre-dough production, 100 g flour, 100 g water, 2.5×10⁹ cfu of the respective Lactobacillus strain (LCT 142, LCT 986, or LCT 1916), and 2×10¹⁰ cfu of Propionibacterium strain LCT P1 were mixed for 3 min using a handheld mixer and were incubated at 37° C. for 20 hours. A blank was prepared as above, but without Lactobacillus and Propionibacterium cells.

After incubation, the resulting pre-dough was analyzed for organic acid production and pH; results are shown in Table 1.

TABLE 1
Pre-dough analysis

| | Propionic acid | Lactic acid | |
|---|---|---|---|
| Lactobacillus strain | [mg/kg] | [mg/kg] | pH |
| none (Blank) | <10 | 1690 | 4.51 |
| LCT 142 | 855 | 11649 | 3.47 |
| LCT 986 | 989 | 9594 | 3.70 |
| LCT 1916 | 1041 | 4000 | 4.19 |

Clearly, substantial amounts of lactic acid and propionic acid are produced.

### EXAMPLE 3: MAIN DOUGH PRODUCTION

For main dough production, to 400 g flour, 200 g water, 10 g salt, 15 g fresh yeast and 5 g gluten, the complete pre-dough of the blank, sample LCT 142, or sample LCT 986, respectively, of Example 1, 100 ppm Veron AX Acid® (an amylase/xylanase enzyme mixture), and 50 ppm ascorbic acid were mixed for 8 min (2 min slow and 6 minutes fast). Subsequently the dough was rested for 30 minutes at room temperature, scaled and the pieces were rested again. The dough was formed and incubated under 80% relative humidity and at 32° C. for 80 min. As a positive control, a blank dough with 0.1% Ca-Propionate was prepared.

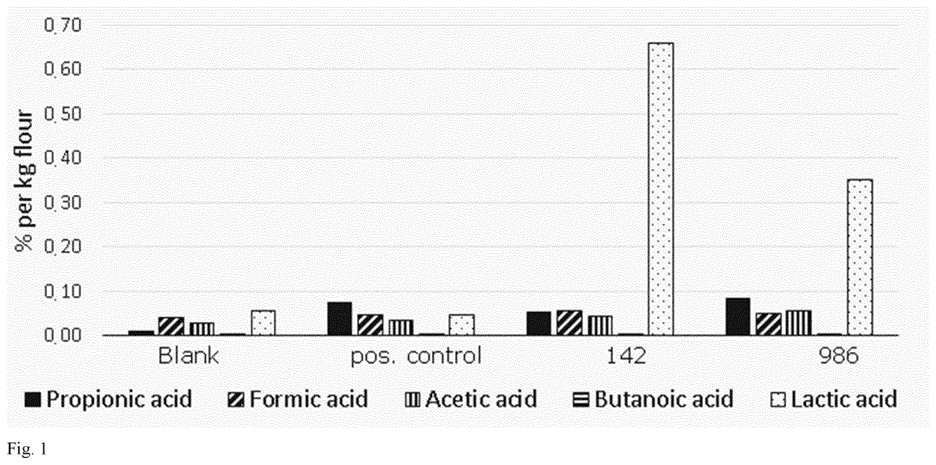

After incubation, the resulting main dough was analyzed for volatile organic acid production and pH; pH results are shown in Table 2, volatile acid results in FIG. 1.

TABLE 2
Main dough pH analysis

| Condition | pH |
|---|---|
| Negative Control (blank) | 5.9 |
| Positive Control | 5.9 |
| LCT 142 | 4.5 |
| LCT 986 | 4.9 |

Thus, inclusion of the Lactobacillus and the Propionibacterium strains causes acid to be produced, mainly lactic acid and substantial amounts of propionic acid.

### EXAMPLE 4: SPOILAGE ANALYSIS

The doughs of Example 3 were baked with a standard baking program to form wheat breads. The resulting breads were sliced into 16 slices each. The bread slices were incubated in a normal proofing chamber with air circulation for 30 minutes at 32° C. and a humidity of 80%. After incubation, each slice was packed in a separate plastic bag. All bags were heat sealed and stored at room temperature (20° C.).

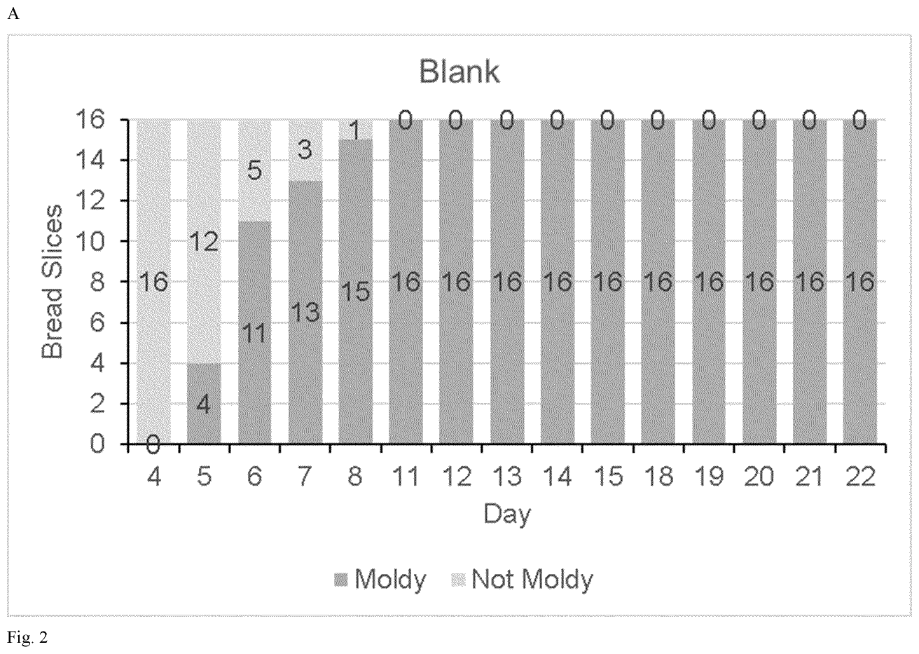

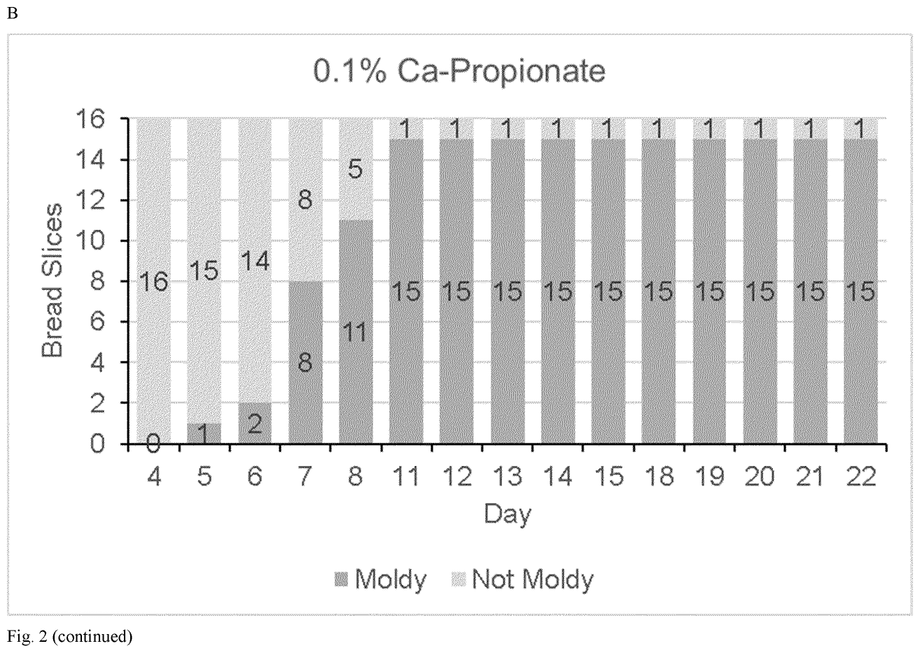

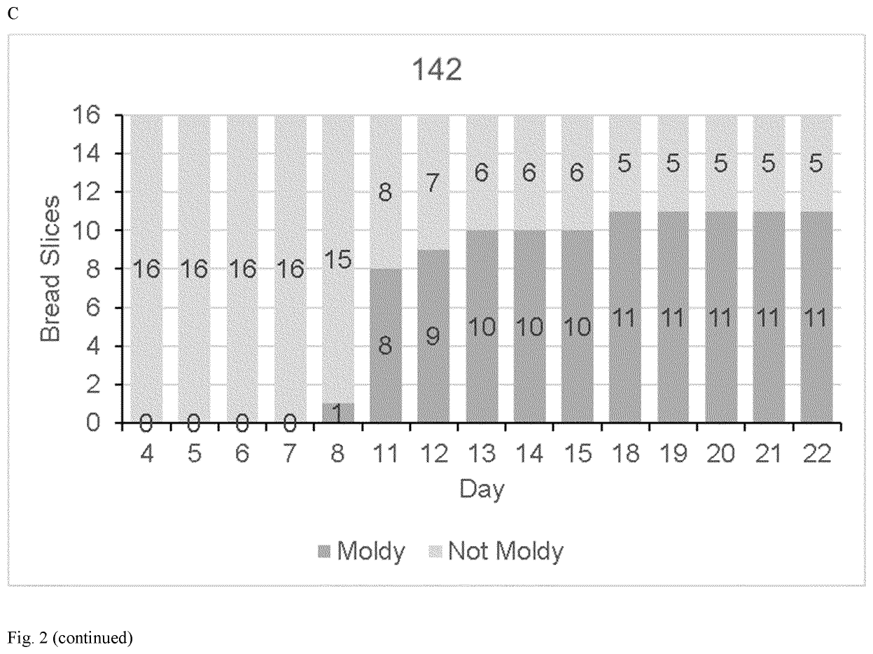

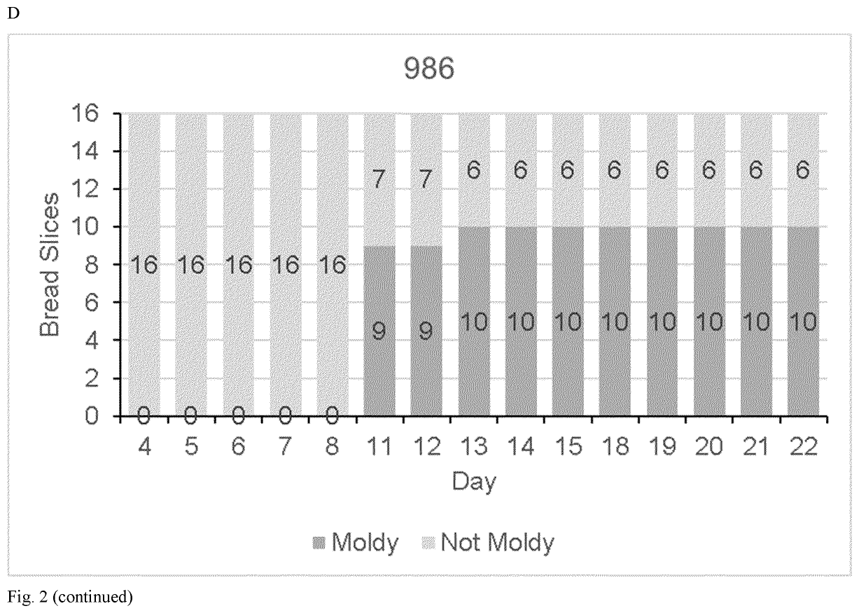

Visible growth of mold was evaluated every day over a period of 22 days; the numbers of moldy and non-moldy slices are shown in FIG. 2A) to D). Clearly, spoilage prevention is improved even over the positive control, i.e. a bread comprising 0.1% Ca-Propionate.

### LITERATURE CITED

Javanainen and Linko (1993), J Cereal Sci 18:75
Javanainen and Linko (1993), J Cereal Sci 18: 171
Ryzhkova (2009), Biotekhnologiya 2:29-37
Ryzhkova et al. (2018) Mikologiy I Fitopatologiya 52:144
Siedler et al. (2019), Curr Op Biotechnol 56:138
Suomalainen and Mäyrä-Mäkinen (1999), Lait 79:165
van der Werf et al (2007) Anal. Biochem. 370:17
Zheng et al. (2020), Int J Syst Evol Microbiol 70:2782
WO 2004/105495 A2
WO 2012/085049 A2
WO 2013/174792 A1
WO 2013/174793 A1

1.-21. (canceled)

22. A method of producing a dough, comprising
(i) admixing a lactic acid producing microorganism and a propionic acid producing microorganism to flour and water; and
(ii) incubating the admixture of step (i) for a first incubation period, wherein the lactic acid producing microorganism produces lactic acid and the propionic acid producing microorganism produces propionic acid,
wherein the lactic acid producing microorganism and the propionic acid producing microorganism are capable of growing in a medium consisting of about 50% (w/w) flour in water.

23. The method of claim 22, wherein the propionic acid producing microorganism is a strain of a Propionibacterium species or a Lactobacillus species.

24. The method of claim 22, wherein the propionic acid producing microorganism is:
(a) a strain of Propionibacterium freudenreichii; and/or
(b) an aerotolerant strain of Propionibacterium freudenreichii.

25. The method of claim 22, wherein the lactic acid producing microorganism is a Lactobacillus strain, a Lactilactobacillus strain, or a Companilactobacillus strain.

26. The method of claim 22, wherein:
(a) the lactic acid producing microorganism is a Lactobacillus johnsonii strain, a Lactilactobacillus sakei strain, a Lactiplantibacillus plantarum strain, or a Companilactobacillus farciminis strain; and/or
(b) the propionic acid producing microorganism is a Propionibacterium freudenreichii strain.

27. The method of claim 22, wherein the lactic acid producing microorganism is a homofermentative lactic acid producing microorganism.

28. The method of claim 22, wherein:
the lactic acid producing microorganism produces at least one compound inhibiting the natural flora of the flour, of the water, and/or of other compounds optionally added to the dough; and optionally,
wherein the production of inhibitory compounds is tested (i) by determining inhibition zones surrounding colonies of the lactic acid producing microorganism on test plates and/or (ii) by producing a dough followed by optical and/or olfactory inspection, wherein inhibition of the natural flora is identified if a homogenous dough with an agreeable, fresh smell is obtained after the first incubation period.

29. The method of claim 22, wherein the lactic acid producing microorganism and/or the propionic acid producing microorganism is/are aerotolerant.

30. The method of claim 22, wherein the lactic acid producing microorganism and the propionic acid producing microorganism are aerotolerant.

31. The method of claim 22, wherein the propionic acid producing microorganism is a strain of Propionibacterium freudenreichii, and wherein the lactic acid producing microorganism is a strain of Lactobacillus johnsonii, Lactilactobacillus sakei, Lactiplantibacillus plantarum, or Companilactobacillus farciminis.

32. The method of claim 22, wherein the lactic acid producing microorganism is
(a) Lactobacillus johnsonii strain LCT 986, deposited at the DSMZ under deposit number DSM 33691;
(b) Lactilactobacillus sakei strain LCT 142, deposited at the DSMZ under deposit number DSM 33690; or
(c) Companilactobacillus farciminis strain LCT 1916, deposited at the DSMZ under deposit number DSM 33692.

33. The method of claim 22, wherein the propionic acid producing microorganism is Propionibacterium freudenreichii strain LCT P1, deposited at the DSMZ under deposit number DSM 33694.

34. The method of claim 22, wherein the first incubation period in step (ii) has a duration of from about 0.5 hour to about 72 hours and/or wherein the first incubation period in step (ii) is performed at a temperature of from about 3° C. to about 50° C.

35. The method of claim 22, wherein after the first incubation period, the propionic acid content of the dough is at least 0.02% (w/w), preferably at least 0.05% (w/w).

36. The method of claim 22, wherein the method further comprises the steps:
(iii) admixing the admixture of step (ii) to flour, water, and yeast; and
(iv) incubating the admixture of step (iii) for a second incubation period.

37. The method of claim 22, wherein the method is a method of increasing a shelf life of a baked good, preferably a wheat bread.

38. A composition, preferably a starter culture for bakery good production, comprising viable cells of a lactic acid producing microorganism and viable cells of a propionic acid producing microorganism, wherein the lactic acid producing microorganism and the propionic acid producing microorganism are capable of growing in a medium consisting of about 50% (w/w) flour in water.

39. A baked good produced or producible by the method according to claim 22, preferably wherein the baked good has an increased shelf-life, and preferably has an increased period of non-spoilage by mold.
